(19) United States
(12) Patent Application Publication
(10) Pub. No.: US 2026/0219722 A1
(43) Pub. Date: Jul. 30, 2026

(54) INFORMATION PROCESSING DEVICE, CONTROL METHOD FOR SAME, AND PROGRAM

(71) Applicant: Sony Interactive Entertainment Inc., Tokyo (JP)

(72) Inventors: Junya Miura, Kanagawa (JP); Hideyuki Saito, Chiba (JP); Hiroshi Kyusojin, Tokyo (JP); Atsushi Okumura, Tokyo (JP); Minami Nagi, Kanagawa (JP)

(21) Appl. No.: 19/574,029

(22) Filed: Mar. 20, 2026

Related U.S. Application Data
(63) Continuation of application No. PCT/JP2024/032604, filed on Sep. 11, 2024.

(30) Foreign Application Priority Data
Sep. 21, 2023 (JP) 2023-156491

(51) Int. Cl. G06F 1/3234

(52) U.S. Cl. CPC G06F 1/3253

(57) ABSTRACT

An information processing device includes an integrated circuit and a bus connected to the integrated circuit. The integrated circuit includes a bus controller that controls communication using the bus, and transits to any one of multiple states including an active state where communication can be performed and a power saving state where communication is restricted, and a monitoring circuit that records history data concerning the communication using the bus at a prescribed time interval. Whether or not communication will occur at a future inference target time point is inferred based on the communication history data recorded by the monitoring circuit, and if a result of the inference indicates occurrence of communication, the bus controller is caused to transit to the active state.

### CROSS-REFERENCE TO RELATED APPLICATIONS

This application is a Continuation of International Application No. PCT/JP2024/032604, having an International Filing Date of September 11, 2024, which claims the benefit of Japanese Application No. 2023-156491 filed September 21, 2023. This disclosure of the prior application is considered part of the disclosure of this application

### FIELD

The present specification relates to an information processing device including an integrated circuit and a bus, and a control method and a control program therefor.

### BACKGROUND

In general, a built-in integrated circuit of an information processing device is connected to a bus, and communication with another integrated circuit or an external information processing device is performed through this bus.

Some bus controllers for controlling the above-mentioned communication via a bus have a function of suppressing the total power consumption by, e.g., making a transition to a low power consumption (non-active) state when the communication is unnecessary. However, there is a possibility that a communication delay is generated due to this function when recovery from a power saving state is performed, or that this function fails to effectively suppress power consumption according to a frequency of occurrences of the communication.

### SUMMARY

The present specification has been made in view of the above circumstances, and an object thereof is to provide an information processing device capable of efficiently performing communication using a bus, and a control method and a control program therefor.

An information processing device according to one aspect of the present specification includes an integrated circuit and a bus connected to the integrated circuit. The integrated circuit includes a bus controller that controls communication using the bus, and transits to any one of multiple states including an active state where communication can be performed and a power saving state where communication is restricted, and a monitoring circuit that records history data concerning the communication using the bus at a prescribed time interval. The integrated circuit infers whether or not communication will occur at a future inference target time point based on the communication history data recorded by the monitoring circuit, and causes the bus controller to transit to the active state if a result of the inference indicates occurrence of communication.

An information processing device controlling method according to one aspect of the present specification is a control method for an information processing device including an integrated circuit and a bus connected to the integrated circuit, the integrated circuit including a bus controller that controls communication using the bus, and transits to any one of multiple states including an active state where communication can be performed and a power saving state where communication is restricted, and a monitoring circuit that records history data concerning the communication using the bus at a prescribed time interval. The method includes, by the integrated circuit, inferring whether or not communication will occur at a future inference target time point based on the communication history data recorded by the monitoring circuit, and causing the bus controller to transit to the active state if a result of the inference indicates occurrence of communication.

A program according to one aspect of the present specification is a program for controlling an information processing device, the information processing device including an integrated circuit and a bus connected to the integrated circuit, the integrated circuit including a bus controller that controls communication using the bus, and transits to any one of multiple states including an active state where communication can be performed and a power saving state where communication is restricted, and a monitoring circuit that records history data concerning the communication using the bus at a prescribed time interval. The program is configured to cause the integrated circuit to perform a process of inferring whether or not communication will occur at a future inference target time point based on the communication history data recorded by the monitoring circuit, and a process of causing the bus controller to transit to the active state if a result of the inference indicates occurrence of communication. This program may be provided in the form of being stored in a computer-readable and non-transitory information storage medium.

### BRIEF DESCRIPTION OF THE DRAWINGS

FIG. 1 is a configuration block diagram depicting a configuration example of an information processing device according to an implementation of the present specification.

FIG. 2 is a diagram depicting one example of data stored in a history buffer.

FIG. 3 is a diagram for illustrating one example of a process of inferring whether or not communication will occur at an inference target time point in the present implementation.

FIG. 4 is a flowchart of one example of a control flow that is executed at a sub-chip.

FIG. 5 is a time chart for illustrating an example of a case of storing data in three types of history buffers.

### DETAILED DESCRIPTION

Hereinafter, an implementation of the present specification will be explained in detail with reference to the drawings.

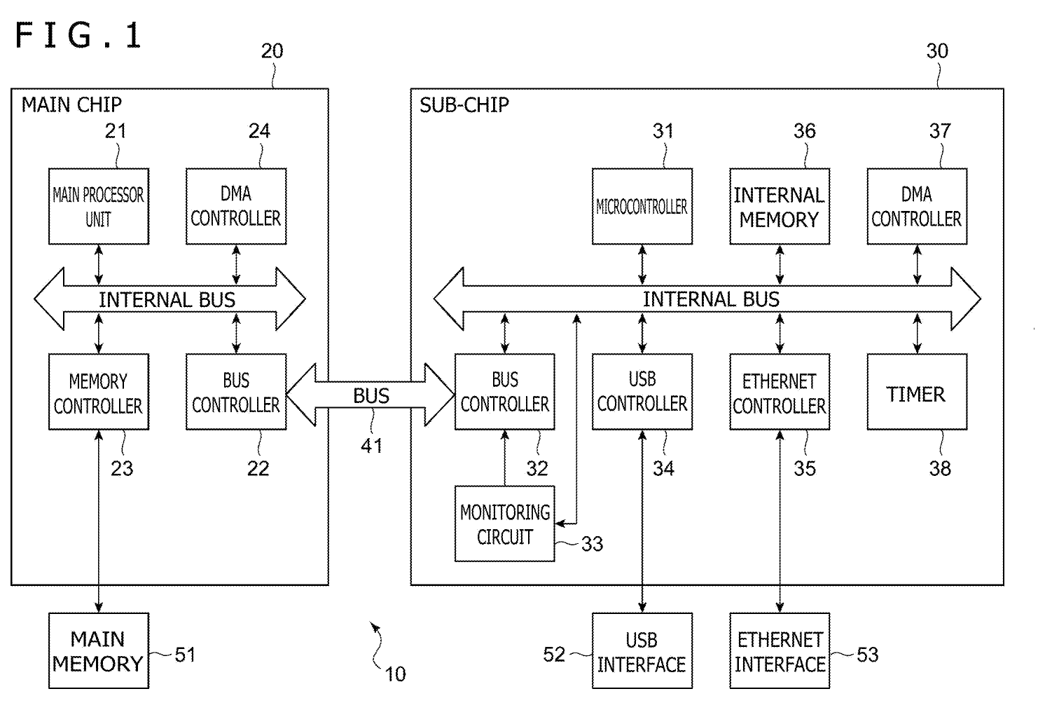

FIG. 1 is a configuration block diagram depicting an information processing device 10 according to one implementation of the present specification. The information processing device 10 is a home-use game machine, a mobile information terminal, a personal computer, or the like, and includes a main chip 20, a sub-chip 30, a bus 41, a main memory 51, a universal serial bus (USB) interface 52 which is a communication interface based on the USB (registered trademark) standard, and an Ethernet interface 53 which is a communication interface using the Ethernet (registered trademark), as depicted in FIG. 1. It is to be noted that the sub-chip 30 of the present implementation is one example of the integrated circuit of the present specification.

The main chip 20 is an integrated circuit in which a processor for executing main information processing for implementing the functions of the information processing device 10 is incorporated. In contrast to the main chip 20, the sub-chip 30 is an integrated circuit in which a processor for implementing an auxiliary function is incorporated, and is mounted as an integrated circuit independent of the main chip 20. The main chip 20 and the sub-chip 30 are connected via the bus 41, and can mutually exchange data via the bus 41.

As depicted in FIG. 1, a main processor unit 21, a bus controller 22, a memory controller 23, and a direct memory access (DMA) controller 24 are incorporated in the main chip 20. It is to be noted that, in addition to those depicted in the drawing, any type of circuits may be additionally incorporated in the main chip 20. Moreover, an interface for establishing connection with any other electronic component not depicted in the drawing may be additionally provided.

The main processor unit 21 is a processor that executes various computations according to a program stored in the main memory 51.

The bus controller 22 is a control circuit for controlling communication with the sub-chip 30 via the bus 41.

The bus 41 is a bus for mutual data communication between the main chip 20 and the sub-chip 30. It is assumed herein that the bus 41 executes the data communication based on a peripheral component interconnect (PCI) Express (registered trademark) standard. However, the implementations of the present specification are not limited to this.

The memory controller 23 is a control circuit connected to the main memory 51. The memory controller 23 controls access to the main memory 51. The DMA controller 24 is a control circuit for realizing direct memory access. These circuits may be implemented by a known technique.

In the present implementation, a microcontroller 31, a bus controller 32, a monitoring circuit 33, a USB controller 34, an Ethernet controller 35, an internal memory 36, a DMA controller 37, and a timer 38 are incorporated in the sub-chip 30. It is to be noted that, in addition to those depicted in the drawing, any type of circuits may be additionally incorporated in the sub-chip 30. Moreover, an interface for establishing connection with any other electronic component not depicted in the drawing may be additionally provided.

The microcontroller 31 is a processor for controlling general operation of the sub-chip 30, and executes various computations according to a program stored in the internal memory 36 or the like.

The bus controller 32 is a control circuit for controlling communication with the main chip 20 via the bus 41. It is assumed herein that the bus controller 32 executes the communication based on the PCI Express standard, as previously explained.

In the present implementation, the bus controller 32 performs control to make a state transition of the bus controller 32 itself in order to reduce power consumption. Specifically, the bus controller 32 transits to any one of multiple states according to the situation. The multiple states include an active state where communication with the main chip 20 can be performed, and a power saving state where the communication is restricted but power consumption is smaller than that in the active state. The bus controller 32 transits to the power saving state when communication with the main chip 20 is not performed, whereby power consumption can be reduced compared to a case where the bus controller 32 continuously operates in the active state. If a request for communication with the main chip 20 is provided after the transition to the power saving state, the bus controller 32 transits to the active state, and after completion of the transition, transmits the requested data to the main chip 20.

The monitoring circuit 33 monitors and records the state of communication using the bus controller 32. Specifically, each time a prescribed unit time elapses, the monitoring circuit 33 monitors whether or not communication was performed within the unit time, and records, in a prepared data buffer (hereinafter, referred to as history buffer), communication history data which indicates the monitoring result. The content of the recorded communication history data is checked by the microcontroller 31, and used to control the bus controller 32. The details of the content recorded by the monitoring circuit 33 and a specific example of the control using the content will be explained later.

The USB controller 34 is a control circuit connected to the USB interface 52. Via the USB interface 52, the USB controller 34 executes data communication with a USB device connected to the information processing device 10.

The Ethernet controller 35 is a control circuit connected to the Ethernet interface 53. Via the Ethernet interface 53, the Ethernet controller 35 executes data communication with a network device connected to the information processing device 10.

The internal memory 36 stores some of programs to be executed by the microcontroller 31 and the main processor unit 21 of the main chip 20. In particular, the microcontroller 31 may perform various controls according to a program stored in the internal memory 36.

The DMA controller 37 is a control circuit for realizing direct memory access. The timer 38 is an electronic circuit that implements a clocking function. These circuits may be implemented by a known technique.

One example of a flow of a data transfer from the sub-chip 30 to the main chip 20 in the present implementation will be explained below. As a specific example thereof, a case where a packet sent from the USB interface 52 is stored in the main memory 51 via the sub-chip 30 and the main chip 20 will be now explained. First, a data packet to be transmitted is stored in a data buffer of the USB controller 34 of the sub-chip 30. In response to this, the USB controller 34 starts a data transfer using direct memory access.

If the bus controller 32 is in the active state, the data transfer is immediately executed via the bus controller 32. If the bus controller 32 is in the power saving state, however, the bus controller 32 first receives a data transfer request and makes a transition from the power saving state to the active state. After the transition is completed, the data transfer is executed. When a certain time has elapsed after completion of the transition, the bus controller 32 transits to the power saving state again, as previously explained.

Meanwhile, a certain time period is required for the transition from the power saving state to the active state. A time period required for the transition from the power saving state to the active state is referred to as a restoration time Tx hereinbelow. During the transition, data waiting for transmission is on standby in the data buffer of the USB controller 34.

According to the USB standard, an isochronous transfer in which data is transferred at a fixed time interval is supported. Assuming that a request for a USB data transfer is issued every 125 μs and the restoration time Tx is 70 μs, only 55 μs are left until the next packet comes by an isochronous transfer. Therefore, if the next packet comes before the data transfer from the USB controller 34 is completed due to coincidence of other data communication or the like, packet loss may occur because the data transfer is not completed in time. Furthermore, if the data transfer fails, re-transmission is usually performed after the elapse of a certain period of time, but during this period, the bus controller 32 may transit to the power saving state again. If so, restoration to the active state is required again before the re-transmission. This can cause repetition of data transfer failures.

To this end, in the present implementation, the microcontroller 31 predicts an estimated timing of occurrence of a next data transfer using the monitoring result obtained by the monitoring circuit 33, and causes the bus controller 32 to transit to the active state in advance based on the prediction result. Accordingly, compared to a case where a transition to the active state is made after a request for a data transfer is actually provided, a waiting time till a data transfer can be shortened, whereby the possibility of packet loss can be reduced.

Specifically, each time a prescribed unit time Δt elapses, the monitoring circuit 33 sequentially records, in the history buffer, communication history data indicating whether or not communication occurred within the unit time Δt. The unit time Δt represents a cycle at which the monitoring circuit 33 records communication history data indicating whether or not communication occurred.

The history buffer in which communication history data is stored by the monitoring circuit 33 may be a previously prepared data buffer of a prescribed size. The history buffer may function as a queue in which information items are sequentially deleted in the order from the oldest one when a new information item is added. With this buffer, the communication history data is recorded to constantly indicate a timing of occurrence of data communication within the latest past prescribed time period.

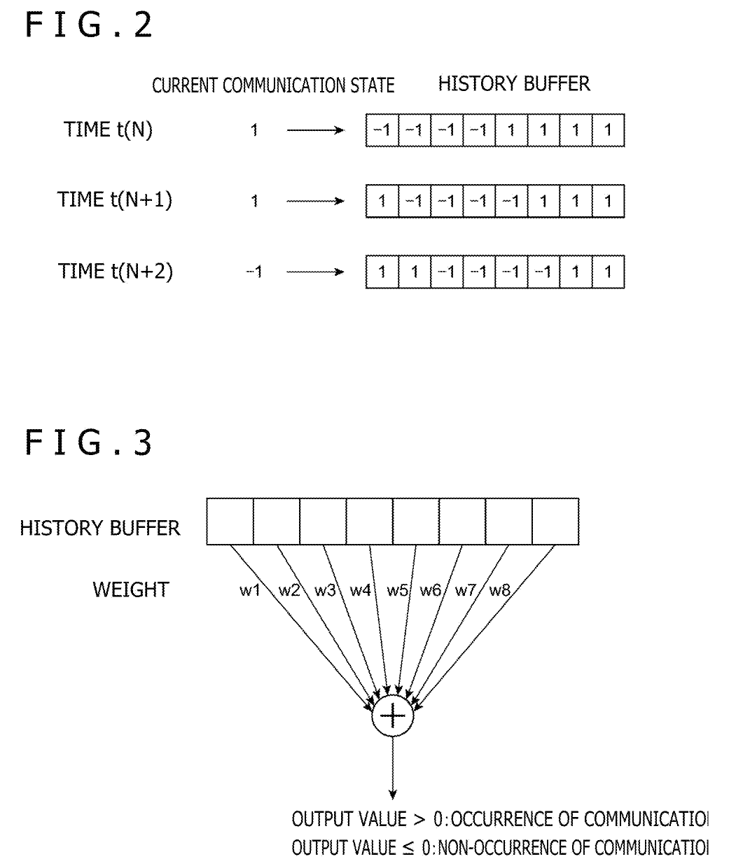

FIG. 2 is a diagram depicting a transition of data stored in the history buffer. In FIG. 2, the history buffer is simplified for explanation, and depicted as a right shift register capable of storing 8 data items. In the drawing, a value "1" stored in the history buffer indicates the presence of data communication while a value "-1" indicates the absence of data communication. Further, in the drawing, the content of the history buffer at time t(N), the content of the history buffer at time t(N+1), and the content of the history buffer at time t(N+2) are depicted from the top to the bottom. It is to be noted that N, N+1, N+2, ... represents a time counter value (integer value) which is counted up every unit time Δt.

In the example depicted in the drawing, the values in the history buffer at time t(N) indicate that data communication was not present, not present, not present, not present, present, present, present, and present at respective past times t(N-1), t(N-2), ... t(N-8). The communication occurred at the time t(N), and thus, "1" which indicates the state at time t(N) is stored at the leftmost of the history buffer at time t(N+1). Simultaneously, the past data items are shift to the right by one, and the data item of the time t(N-8) stored at the rightmost at time t(N) is discarded at time t(N+1). At a timing where time t(N+2) comes after time t(N+1), the content of the history buffer is also updated in the similar manner. As a result, communication history data indicating the communication states at time t(N+1), time t(N), time t(N-1), ... time t(N-6) in order from the leftmost is stored in the history buffer at time t(N+2).

Using the content of the history buffer recorded in this manner, the microcontroller 31 predicts a communication state at a future time point. Specifically, the microcontroller 31 infers whether or not communication using the bus 41 will occur before the restoration time Tx elapses from the current time point. When the bus controller 32 is currently in the power saving state and occurrence of communication at a future time point is inferred, control is performed to restore the active state of the bus controller 32.

By way of example, each time the unit time Δt elapses, the microcontroller 31 infers whether or not communication will occur at a time point (inference target time point) after the elapse of the restoration time Tx from the current time point. In a case where occurrence of communication at the inference target time point is inferred, the microcontroller 31 generates an interruption request for immediate restoration of the active state of the bus controller 32. Accordingly, the bus controller 32 can be restored to the active state by a timing when the inference time point actually comes.

In addition, in a case where the bus controller 32 is currently in the active state and non-occurrence of communication till the elapse of the restoration time Tx from the current time point is inferred, the microcontroller 31 may perform control to cause the bus controller 32 to transit to the power saving state. Accordingly, in a case where non-occurrence of communication for the time being is inferred, a transition of the bus controller 32 to the power saving state can be made before a prescribed waiting time elapses.

Here, a specific example of inferring whether or not communication will occur at an inference target time point will be explained with reference to FIG. 3. By way of example, it is assumed that the microcontroller 31 makes the inference using an inference model of a single-layer perceptron. In this case, the same number of weights w as that of the data items stored in the history buffer are prepared as parameters to be used by the inference model. For the example of the history buffer in FIG. 2, for example, eight weights w1, w2, ... w8 are prepared respectively for the eight data items. Using these eight weights w, the microcontroller 31 multiplies each input value by the corresponding weight, that is, multiples the value (+1 or -1) of the first data item in the history buffer by w1, multiples the value of the second data item by w2, and so on. Then, the sum of the resultant values is outputted. If this output value is positive, the inference is determined to indicate occurrence of communication. If this output value is 0 or less, the inference is determined to indicate non-occurrence of communication. When the number of the data items is n, the output value can be calculated by a quantity of an O(n) calculation. Even if the number of data items stored in the history buffer is increased, the inference can be made with a relatively small calculation load.

Subsequently, in a case where a result of the inference is incorrect (that is, in a case where there is a difference between a result of the inference and the actual communication state), the microcontroller 31 corrects the values of the weights at the current time point using a prescribed learning rate. As a result of repetition of a learning process of correcting the parameters to be used by the inference model when a result of the inference is incorrect, the accuracy of the following inferences can be improved even if the first-time inference fails. Accordingly, in a case where communications cyclically occur, the presence/absence of communication can be inferred with high accuracy. The learning result is reflected in this manner, so that the accuracy can be improved. Therefore, predetermined fixed values or randomly determined values may be set as the initial values of the weights w for a startup time of the information processing device 10.

It is to be noted that the inference is made each time the unit time Δt elapses in the present implementation, but alternatively, the microcontroller 31 may make the inference each time a prescribed time that is longer than the unit time Δt elapses. In either case, each time the microcontroller 31 makes the inference, the microcontroller 31 holds the inference result data items of a time period corresponding to the restoration time Tx. By checking the held data items concerning the inference results, whether or not the inference indicates occurrence of communication before the elapse of the restoration time Tx can be determined. In addition, when the inference target time point actually comes, the held inference results are checked to inspect whether or not the inferences were correct, and then, the inspection result can be reflected in the learning process.

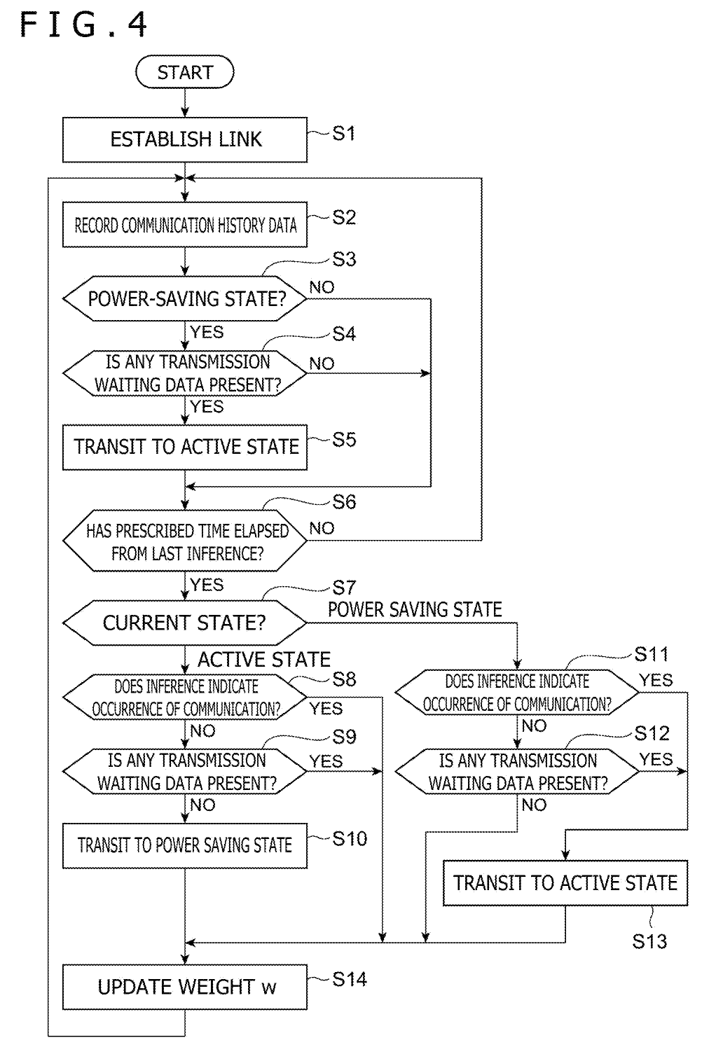

One example of a control flow that is executed by the sub-chip 30 in the present implementation will be explained below with reference to the flowchart in FIG. 4. It is to be noted that a prescribed constant C is used in this example such that the inference is made each time a time period that is C times as long as the unit time Δt elapses.

When a link is established between the main chip 20 and the sub-chip 30 via the bus 41 (S1), the following flow is steadily executed each time the unit time Δt elapses until the link is disconnected.

First, the monitoring circuit 33 records, in the history buffer, new communication history data indicating whether data communication using the bus 42 is currently present (S2). Then, the bus controller 32 performs control to cause a state transition according to the current state. Specifically, in a case where the current state is the power saving state (S3) and there is data waiting for transmission (S4), a transition to the active state is immediately started (S5). This transition is a transition that is required when the inference based on the communication history is incorrect and unexpected communication occurs.

Thereafter, the value of the time counter is incremented, and whether the time counter value is the integral multiple of the prescribed constant C is determined. This is performed to determine whether a time period corresponding to C∙Δt has elapsed from execution of an inference process (explained later) after the last affirmative determination (S6). If the prescribed time period has not elapsed, the flow returns to S2 after elapse of the unit time Δt. Then, the loop is repeated.

If the time period corresponding to C∙Δt is determined to have elapsed, the flow is separated to branches according to the current state of the bus controller 32 (S7).

If the current state of the bus controller 32 is the active state, whether or not communication will occur at an inference target time point in the future is inferred (S8). If a result of the inference indicates non-occurrence of communication at the inference target time point in the future and no data to be transmitted now is present (S9), a transition to the power saving state is made (S10). In contrast, if a result of the inference indicates occurrence of communication at the inference target time point in the future, a state transition is not required. In addition, if data to be transmitted now is present, a transition to the power saving state naturally cannot be made.

On the other hand, if the current state of the bus controller 32 is the power saving state, whether or not communication will occur at the inference target time point in the future is also inferred (S11). If a result of the inference indicates occurrence of communication at the inference target time point in the future, a transition to the active state is started (S13). Also, if data to be transmitted now is present (S12), a transition to the active state is started (S13). In contrast, if no data to be transmitted now is present and a result of the inference indicates non-occurrence of communication until the inference target time point in the future, a state transition is not required.

Subsequently, the microcontroller 31 updates the weights w according to a result of collation between the past inference results and the presence/absence of current actual communication (S14). After the elapse of the unit time Δt, the flow returns to S2. Then, the loop is repeated.

As a result of this control, whether or not communication will occur in a future is constantly inferred, a state transition of the bus controller 32 is made according to a result of the inference, and if the inference is incorrect, a learning process is performed, so that the accuracy of the next and succeeding inferences can be improved.

Next, an example will be explained in which inference control using multiple types of history buffers is performed. It is assumed here that multiple types of data transfer requests are provided at different cycles. In one example, a request for a data transfer through the USB interface 52 is provided every 1000 μs (= 1 ms) while a request for a data transfer through the Ethernet interface 53 is provided every 200 μs. It is to be noted that, in general, transfers through the Ethernet interface 53 are a combination of regular cyclic transfers of videos or sounds and asynchronous transfers, but a request for a transfer that occurs at a regular cycle will be considered herein.

In the explanation given so far, the communication history data is stored in the history buffer of one type having a fixed size. In this case, in order to estimate timings of data transfers that occur at a cycle of 1 ms, the history buffer is required to have a size large enough to store communication history data of a time period longer than this cycle. In a case where the unit time Δt is 10 μs and the presence/absence of a data transfer is recorded every unit time Δt, a history buffer capable of holding at least 100 data items is required in order to hold a communication history of a time period longer than 1 ms. In a case where a longer cycle of transfer requests is assumed, a history buffer capable of holding more than 1660 data items is required when the cycle of a requested transfer is e.g. 16.6 ms. When the number of data items that can be stored in a history buffer is increased, not only the size of the history buffer but also the number of parameters (weights) necessary for inferring the presence/absence of communication is increased. Accordingly, a calculation quantity necessary for the inference is also increased.

When the unit time Δt which is a cycle of recording the presence/absence of a data transfer is lengthened, a communication history of a long time period can be held with a smaller number of history buffers. However, when the unit time Δt is lengthened, it is difficult to predict a relatively short cycle of data transfers. For example, to predict timings of data communication that occurs every 200 μs, it is necessary to set the unit time Δt to be much shorter than 200 μs.

To this end, the monitoring circuit 33 may include multiple types of history buffers to respectively record communication history data at different time intervals. As a specific example, a case of recording the communication history in three types of history buffers will now be explained. Hereinafter, it is assumed that the three types of the history buffers are a history buffer 1, a history buffer 2, and a history buffer 3, and data is recorded in these history buffers at respective time intervals of the unit times Δt1, Δt2, and Δt3. Here, Δt1 < Δt2 < Δt3.

Each time the unit time Δt1 elapses, the monitoring circuit 33 records, in the history buffer 1, communication history data indicating the presence/absence of communication using the bus 41 within the unit time Δt1. In parallel with this, each time the unit time Δt2 elapses, communication history data indicating the presence/absence of communication within the unit time Δt2 is recorded in the history buffer 2. Likewise, each time the unit time Δt3 elapses, communication history data indicating the presence/absence of communication within the unit time Δt3 is recorded in the history buffer 3. Each of these history buffers independently functions as a first-in first-out queue. Each time new data is added to the history buffer, the oldest data in the same history buffer is discarded.

By way of example, it is assumed that Δt1 = 1 μs, Δt2 = 50 μs, Δt3 = 1000 μs, and up to 300 data items are stored in each of the history buffers. In this case, communication history data of the last 300 μs is recorded in the history buffer 1 at a cycle of 1 μs. Likewise, communication history data of the last 15 ms is recorded in the history buffer 2 at a cycle of 50 μs, and communication history data of the last 300 ms is recorded in the history buffer 3 at a cycle of 1000 μs (= 1 ms). Accordingly, communication history data of up to the last 300 ms can be recorded while the total number of data items recorded in the history buffers can be restricted to 900.

Using the data stored in these three history buffers, the microcontroller 31 infers whether or not data communication will occur at an inference target time point in the future. Timings of this inference may be set according to the timings of recording the target data in the respective history buffers. For example, the microcontroller 31 may make the inference using the data currently stored in the history buffer 1 each time the unit time Δt1 elapses, make the inference using the data currently stored in the history buffer 2 each time the unit time Δt2 elapses, and make the inference using the data currently stored in the history buffer 3 each time the unit time Δt3 elapses. Then, any of the inferences indicates occurrence of communication in the future, control is performed to cause the bus controller 32 to restore the active state from the power saving state.

Moreover, for different inference target time points, the microcontroller 31 may make the inferences based on the communication history data recorded by the different cycles. The above explanation is based on the assumption that the bus controller 32 takes only two states: the active state and one power saving state, and a future time point after the restoration time Tx which is required to restore the active state from the power saving state is defined as the inference target time point. However, the bus controller 32 may have several types of states as power saving operation states. These power saving states are different in power consumptions. In general, a state in which power consumption is lower takes a longer restoration time to restore the active state.

In a specific example, it is assumed that the bus controller 32 can operate in any one of three power saving states. Hereinafter, the three power saving states are referred to as power saving state 1, power saving state 2, and power saving state 3, and time periods required to restore the active state from these states are referred to as restoration times Tx1, Tx2, Tx3, respectively. Here, Tx1 < Tx2 < Tx3. That is, a restoration from the power saving state 1 to the active state can be performed most quickly, but the power consumption in the power saving state 1 is larger than those in the other power saving states instead.

In this example, the microcontroller 31 may perform control to cause a transitions to each of the multiple power saving states using a result of an inference based on communication history data stored in a corresponding one of the multiple types of history buffers. Specifically, in a case where an inference is made using communication history data of a relatively short period recorded by a short cycle, a prediction about a near future can be made but it is difficult to make a prediction about a distant future with high precision. Therefore, to determine whether or not to make a transition to a power saving state from which a transition to the active state can be made within a relatively short restoration time Tx, a result of an inference using a history buffer having a short cycle of recording communication history data is suitably used. In contrast, to control a transition to a power saving state for which a long restoration time Tx is required, a result of an inference using communication history data recorded by a relatively long cycle is desirably used.

Therefore, the microcontroller 31 infers the presence/absence of occurrence of communication at a future inference target time point which is a time point after the elapse of the restoration time Tx1 from the current time point based on the communication history data recorded in the history buffer 1. Then, if the current state of the bus controller 32 is the active state, whether or not to cause a transition to the power saving state 1 is determined based on a result of the inference. That is, in a case where a result of the inference using the communication history data in the history buffer 1 indicates non-occurrence of communication till the elapse of the restoration time Tx1 from the current time point, the bus controller 32 is caused to transit to the power saving state 1. Likewise, the microcontroller 31 makes the inference about a time point after the elapse of the restoration time Tx2 from the current time point using communication history data in the history buffer 2, and controls a transition to the power saving state 2 based on a result of the inference. Also, the microcontroller 31 makes the inference about a time point after the elapse of the restoration time Tx3 from the current time point using communication history data in the history buffer 3, and controls a transition to the power saving state 3 based on a result of the inference.

It is to be noted that, in order to effectively make these inferences, it is preferable to determine a time interval of recording communication history data in each history buffer according to a restoration time Tx required for a transition from each power saving state to the active state. That is, a cycle of storing communication history data in each history buffer (i.e., unit time Δt1, Δt2, and Δt3) is determined so as to achieve a sufficiently shorter time interval of recording communication history data than the restoration time Tx required for the corresponding power saving state. Accordingly, the inferences can be effectively made for future inference target time points corresponding to the restoration times Tx required from the respective power saving states. It is to be noted that the monitoring circuit 33 may determine a cycle of recording communication history data in each of the history buffers by checking a value held in a register or the like. In this case, when the microcontroller 31 updates the value in the register on the basis of, for example, the operation state of the information processing device 10 or the content of the communication history, the cycle of recording communication history data can be dynamically changed.

Furthermore, regarding the control of a transition to a power saving state using multiple types of communication history data, priority may be given to control using communication history data recorded at a relatively long time interval. That is, if a result of the inferences based on the communication history data in the history buffers indicates that a transition to multiple power saving states can be made, a transition to the power saving state that requires the lowest power consumption is determined. By way of example, if all of the inferences based on the communication history data in the history buffers 1, 2, and 3, indicate non-occurrence of communication within an inference target period, the bus controller 32 is caused to transit to the power saving state 3. Accordingly, the power consumption in the bus controller 32 can be further suppressed.

It is to be noted that if a result of the inference based on the communication history data in any one of the history buffers indicates occurrence of communication after the elapse of the corresponding restoration time Tx, a transition to the active state needs to be made according to that timing. Therefore, if an inference result that indicates occurrence of communication is obtained by any one of the inferences, irrespective of the priority levels, the microcontroller 31 causes the bus controller 32 to transit to the active state.

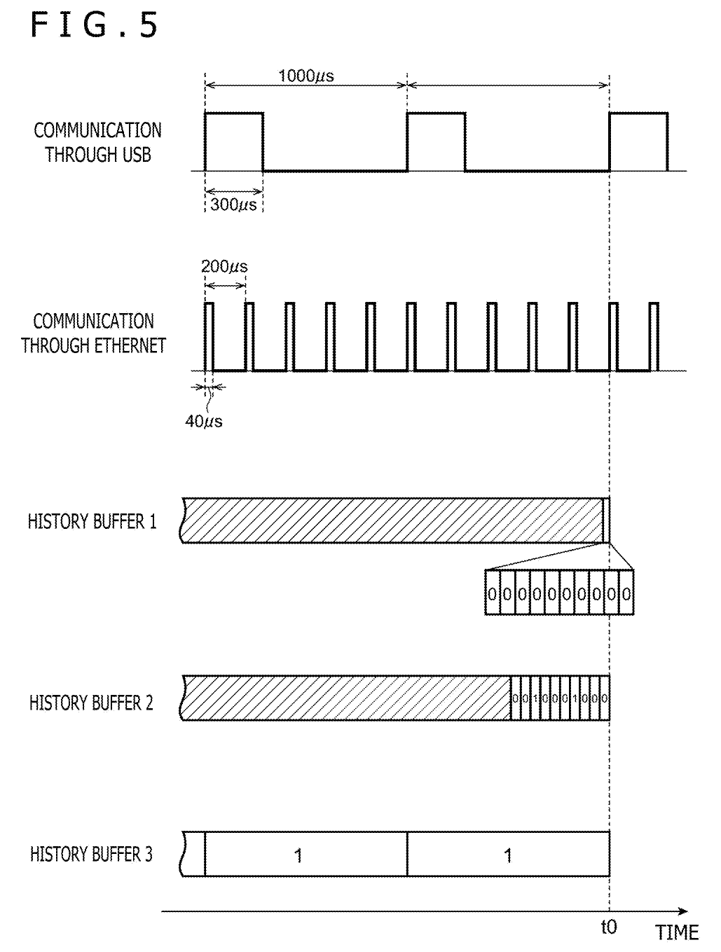

FIG. 5 is a diagram for illustrating a specific example of a case in which communication history data is stored in the three types of history buffers explained above. In the example in this drawing, data communication through the USB controller 34 occurs every 1000 μs, and a time period of 300 μs is taken to perform this communication one time. In addition, data communication through the Ethernet controller 35 occurs every 200 μs, and a time period of 40 μs is taken to perform this communication one time. Further, intervals of recording communication history data in the history buffers 1, 2, and 3 are respectively 1 μs, 50 μs, and 1000 μs, time t0 is defined as the current time point for simplicity, and communication history data obtained by the last ten-times inferences are recorded. It is to be noted that, in the depicted example, a value "1" as communication history data stored in a history buffer indicates the presence of data communication while a value "0" indicates the absence of data communication. In the drawing, the hatched parts represent old communication history data discarded after ten-time inferences.

In this depicted example, the communication history data stored in the history buffer 3 indicates that communication will constantly occur. Therefore, it is considered that control to cause a transition to the power saving state 3 is not performed at this time point based on the communication history data in the history buffer 3. On the other hand, in the history buffer 2 which records communication history data every unit time of 50 μs which is shorter than 160 μs because there is a time period of up to 160 μs in which no communication occurs, there is a timing in which the communication history data items indicating non-occurrence of communication are successively held. Thus, according to an inference timing, a determination to perform control to cause a transition to the power saving state 2 can be made. Also, if a transition to the power saving state 2 is not allowed by a determination based on the communication history data in the history buffer 2 but the inference based on the communication history data in the history buffer 1 indicates that no communication will occur in the restoration time Tx1, control to cause a transition to the power saving state 1 is made. Accordingly, if it is inferred that restoration to the active state will not be completed within the restoration time Tx2, the bus controller 32 is caused to transit to the power saving state 1, from which the active state can be restored within the shorter restoration time Tx1, whereby the power consumption can be reduced.

As explained so far, with the information processing device 10 according to the present implementation, whether or not communication will occur at a future time point is inferred based on communication history data recorded at a prescribed time interval, and control to cause the bus controller 32 to transit to the active state is performed on the basis of a result of the inference. Accordingly, a wait time during which communication cannot be performed till completion of a state transition can be shortened. In addition, control to cause the bus controller 32 to transit to the power saving state is performed on the basis of a result of the inference, whereby power consumption in the bus controller 32 can be further reduced.

It is to be noted implementations of the present specification are not limited that explained above, and various modifications can be made. For example, the number of types of the power saving states, the number of history buffers, the value of the unit time Δt which represents a cycle of storing data in a history buffer in the above explanation are just examples, and any value can be adopted therefor according to the actual specifications of the bus controller, etc. In addition, the manner of inferring whether or not communication will occur at a future time point using the communication history data in the above explanation is just an example, and the inference may be made in a difference manner.

In the above explanation, the microcontroller 31 of the sub-chip 30 executes a prepared control program to perform control of inferring the presence/absence of occurrence of communication based on the communication history data and control of a transition of the bus controller 32 based on a result of the inference. However, part or whole of the controls which have been performed by the microcontroller 31 in the present implementation may be performed by a control circuit implemented as hardware. In this case, the control circuit performs the inference process according to a fixed algorithm but parameters required for this operation may be stored in a register or the like, and be updated if needed. Accordingly, even in a case where the control circuit that executes the inference process is implemented by hardware, the content of the process can be modified according to conditions.

In addition, in the above explanation, the bus 41 is connected so as to allow data communication between the sub-chip 30 and the main chip 20, and is used for communication between these chips. However, a bus of the present specification is not limited to the bus 41. For example, a bus for establishing connection between the information processing device and an external device may be adopted. Also in this case, to cause a transition of a bus controller controlling the communication using the bus to the active state or power saving state, whether or not communication will occur at a future inference target time point is inferred based on communication history data obtained by the monitoring circuit monitoring the communication, and the state of the bus controller is controlled on the basis of a result of the inference. Accordingly, a waiting time for restoration to the active state can be shortened.

### Reference signs list:

10: Information processing device

20: Main chip

21: Main processor unit

22: Bus controller

23: Memory controller

25: DMA controller

30: Sub-chip

31: Microcontroller

32: Bus controller

32: Monitoring circuit

34: USB controller

35: Ethernet controller

36: Internal memory

37: DMA controller

38: Timer

41: Bus

51: Main memory

52: USB interface

53: Ethernet interface

What is claimed is:

1. An information processing device comprising:
a bus; and
an integrated circuit that is connected to the bus, the integrated circuit comprising:
a bus controller that is configured to control communication using the bus, and that is configured to transit to any one of multiple states including (i) an active state in which communication is capable of being performed, and (ii) a power saving state in which communication is restricted, and
a monitoring circuit that is configured to record history data relating to the communication using the bus at a prescribed time interval,
wherein:
the integrated circuit is configured to:
infer whether or not communication will occur at a future inference target time point based at least on the communication history data that is recorded by the monitoring circuit, and
cause the bus controller to transit to the active state when a result of the inference indicates that communication will occur at the future inference target time point.

2. The information processing device of claim 1, wherein:
the integrated circuit is configured to cause the bus controller to transit according to the power saving state when a result of the inference indicates that communication will not occur at the future inference target time point.

3. The information processing device of claim 1, wherein:
the inference target time point is determined based at least on a time period that is required for a transition of the bus controller from the power saving state to the active state.

4. The information processing device of claim 1, wherein:
the integrated circuit is configured to:
infer based at least on an inference model that uses a prescribed parameter, and
execute a learning process to correct the parameter when a result of the inference is determined to be incorrect.

5. The information processing device of claim 1, wherein:
the monitoring circuit is configured to record multiple types of communication history data at different time intervals, and
the integrated circuit is configured to infer using each of the multiple types of communication history data.

6. The information processing device of claim 5, wherein
the bus controller is configured to transits to any one of multiple states including multiple power saving states that require different power consumptions, and
the integrated circuit is configured to cause the bus controller to transit to any one of the multiple power saving states based at least on inferring using each of the multiple types of communication history data.

7. The information processing device of claim 6, wherein:
inference target time points for integrated circuit infers using the multiple types of communication history data are determined based at least on time periods that are each required for a transition of the bus controller from each of the multiple power saving states to the active state.

8. A computer-implemented method comprising:
controlling, by a bus controller of n integrated circuit, communication using a bus;
transiting, by the bus controller of the integrated circuit, according to any one of multiple states including (i) an active state in which communication is capable of being performed, and (ii) a power saving state in which communication is restricted;
recording, by a monitoring circuit, history data relating to the communication using the bus at a prescribed time interval;
inferring, by the integrated circuit, whether or not communication will occur at a future inference target time point based at least on the communication history data that is recorded by the monitoring circuit; and
causing, by the integrated circuit, a bus controller to transit to the active state when a result of the inference indicates that communication will occur at the future inference target time point.

9. The method of claim 1, comprising:
causing, by the integrated circuit, the bus controller to transit to the power saving state when a result of the inference indicates that communication will not occur at the future inference target time point.

10. The method of claim 8, wherein:
the inference target time point is determined based at least on a time period that is required for a transition of the bus controller from the power saving state to the active state.

11. The method of claim 8, comprising:
inferring, by the integrated circuit, based at least on an inference model that uses a prescribed parameter, and
executing, by the integrated circuit, a learning process to correct the parameter when a result of the inference is determined to be incorrect.

12. The method of claim 8, comprising:
recording, by the monitoring circuit, multiple types of communication history data at different time intervals, and
inferring, by the integrated circuit, using each of the multiple types of communication history data.

13. The method of claim 12, comprising:
transiting, by the bus controller, to any one of multiple states including multiple power saving states that require different power consumptions, and
causing, by the integrated circuit, the bus controller to transit to any one of the multiple power saving states based at least on inferring using each of the multiple types of communication history data.

14. The method of claim 13, wherein:
inference target time points for integrated circuit infers using the multiple types of communication history data are determined based at least on time periods that are each required for a transition of the bus controller from each of the multiple power saving states to the active state.

15. A non-transitory computer-readable media that stores instructions which, when executed by one or more processors, causes the one or more processors to perform operations comprising:
controlling, by a bus controller of n integrated circuit, communication using a bus;
transiting, by the bus controller of the integrated circuit, according to any one of multiple states including (i) an active state in which communication is capable of being performed, and (ii) a power saving state in which communication is restricted;
recording, by a monitoring circuit, history data relating to the communication using the bus at a prescribed time interval;
inferring, by the integrated circuit, whether or not communication will occur at a future inference target time point based at least on the communication history data that is recorded by the monitoring circuit; and
causing, by the integrated circuit, a bus controller to transit to the active state when a result of the inference indicates that communication will occur at the future inference target time point.

16. The media of claim 15, wherein the operations comprise:
causing, by the integrated circuit, the bus controller to transit to the power saving state when a result of the inference indicates that communication will not occur at the future inference target time point.

17. The media of claim 15, wherein:
the inference target time point is determined based at least on a time period that is required for a transition of the bus controller from the power saving state to the active state.

18. The media of claim 15, wherein the operations comprise:
inferring, by the integrated circuit, based at least on an inference model that uses a prescribed parameter, and
executing, by the integrated circuit, a learning process to correct the parameter when a result of the inference is determined to be incorrect.

19. The media of claim 15, wherein the operations comprise:
recording, by the monitoring circuit, multiple types of communication history data at different time intervals, and
inferring, by the integrated circuit, using each of the multiple types of communication history data.

20. The media of claim 19, wherein the operations comprise:
transiting, by the bus controller, to any one of multiple states including multiple power saving states that require different power consumptions, and
causing, by the integrated circuit, the bus controller to transit to any one of the multiple power saving states based at least on inferring using each of the multiple types of communication history data.
